(19) United States
(12) Patent Application Publication
(10) Pub. No.: US 2026/0169878 A1
(43) Pub. Date: Jun. 18, 2026

(54) Dynamic Test Pattern File Generation and Modification from Converted Software Testing Code

(71) Applicant: Google LLC, Mountain View, CA (US)

(72) Inventors: Dhivyabharathi Vethanayagam, Bangalore (IN); Kasi Viswanadh Chunduri, Bangalore (IN); Karthikeyan Subramanian, Bengaluru (IN)

(73) Assignee: Google LLC, Mountain View, CA (US)

(21) Appl. No.: 19/531,416

(22) Filed: Feb. 5, 2026

Related U.S. Application Data
(60) Provisional application No. 63/975,845, filed on Feb. 4, 2026.

(51) Int. Cl. G06F 11/263; G06F 11/3668

(52) U.S. Cl. CPC G06F 11/263; G06F 11/3688

(57) ABSTRACT

Apparatus and technique(s) are described that convert compiled hardware design code into a modifiable dynamic test pattern file without performing a simulation of the hardware design, e.g., one in an automatic test equipment (“ATE”) file format. After the dynamic test pattern file is generated, its content may be modified to include a test workload. The test workload enables an ATE workflow to be implemented without regeneration of the dynamic test pattern file.

### CROSS-REFERENCE TO RELATED APPLICATION

This application claims the benefit of U.S. Provisional Patent Application Ser. No. 63/975,845, filed on Feb. 4, 2026, the disclosure of which is incorporated by reference herein in its entirety.

### SUMMARY

Apparatus and technique(s) are described that convert software testing code, e.g., compiled hardware design code, into a modifiable dynamic test pattern file without performing a simulation of the hardware design, e.g., one in an automatic test equipment (“ATE”) file format. After the dynamic test pattern file is generated, its content may be modified to include a test workload. The test workload is configured to enable an automatic test equipment (“ATE”) workflow to occur, which ATE workflow is based on (e.g., uses) the dynamic test pattern file as modified in response to the output. Thus, the test workload stored in the dynamic test pattern file may enable a subsequent ATE workflow to validate and/or test a device under test without regenerating the dynamic test pattern file.

A computer-implemented method begins by receiving, at a computer processor, a compiled hardware design code unique to a hardware design of a component of a computing device. The processor generates, in an automatic test equipment file format from the compiled hardware design code and without performing a simulation of the hardware design, a dynamic test pattern file. In response to an output received through a software interface to modify a content of the dynamic test pattern file, the processor modifies the content to be a test workload of a hardware state of the hardware design. The test workload enables implementation of an automatic test equipment workflow based on the dynamic test pattern file as modified in response to the output. The generating step may further include the processor processing the compiled hardware design code into parsed software code; and converting the parsed software code into the dynamic test pattern file. The content of the dynamic test pattern file may include a register transaction value.

A computing device is disclosed that includes: a processor; a bus; and a computer-readable storage media coupled with the processor and the bus. The computer-readable storage media includes computer-readable instructions that when executed by the processor cause the processor to receive a compiled hardware design code unique to a hardware design of a component of another computing device. The processor generates, from the received compiled hardware design code, a dynamic test pattern file in an automatic test equipment file format without performing a simulation of the hardware design. The processor also generates a software interface. The processor receives an output from the software interface to modify a content of the dynamic test pattern file. In response to the output, processor modifies the content to be a test workload of a hardware state of the hardware design. The test workload enables implementation of an automatic test equipment workflow without regenerating the dynamic test pattern file. The computer-readable storage media may further include computer-readable instructions that when executed by the processor cause the processor to parse the compiled hardware design code into parsed software code; and to convert the parsed software code into the dynamic test pattern file. The computing device may be a component of an automatic test equipment machine.

This document also describes computer-readable storage media having instructions for performing the above-summarized techniques and other techniques set forth herein, as well as systems and means for performing these techniques. This Summary is intended to introduce simplified concepts of systems and techniques directed to a dynamic test pattern file generation and modification mode of a design computing device, concepts of which are further described below in the Detailed Description and Drawings. This Summary is not intended to identify essential features of the claimed subject matter, nor is it intended for use in determining the scope of the claimed subject matter.

### BRIEF DESCRIPTION OF DRAWINGS

Details of one or more aspects of systems and techniques for generating and modifying a dynamic test pattern file directly from compiled hardware design code, are described herein with reference to the following Drawings:

FIG. 1 illustrates example details of an environment in which systems and techniques for generating a dynamic test pattern file from compiled hardware design code may be implemented;

FIG. 2 illustrates example details of operative elements of a design computing device and components of a software application that may generate a dynamic test pattern file from compiled hardware design code and that may modify the dynamic test pattern file;

FIG. 3 illustrates further example details of how a software interface generated by a manipulation component of a software application may modify content within a dynamic test pattern file; and

FIG. 4 illustrates an example method for generating a dynamic test pattern file from compiled code.

The same numbers may be used throughout the Drawings to reference like features and components.

### DETAILED DESCRIPTION

### Overview

This document describes techniques and apparatuses directed at generating and modifying a dynamic test pattern file from compiled hardware design code (hereinafter, “compiled hardware design code”).

The compiled hardware design code and the dynamic test pattern file directly generated from it may each correspond to a hardware design of a component of a computing device. The dynamic test pattern file may be generated in an automatic test equipment (“ATE”) file format, which can be implemented by an ATE machine and/or by an ATE software application. A software interface generated by a manipulation component of a software application described in this document may enable direct programmatic access to the dynamic test pattern file. The software interface may generate an output to one or more computer processor(s) to directly modify (e.g., “manipulate”) content within the dynamic test pattern file, so that an intermediate full functional simulation (e.g., in an Extended Value Change Dump (“EVCD”) file format) of the hardware design is bypassed; and/or so that an ATE workflow based on (e.g., that uses) the dynamic test pattern file, as modified by the output to include the test workload, can be implemented without regenerating the modified dynamic test pattern file.

The described techniques, however, may accelerate ATE workflows of new hardware designs for components of computing devices. This speed results, in part, from a unique modular software application architecture. The software application includes a conversion component that generates a dynamic test pattern file from compiled hardware design code. The software application also includes a separate manipulation component that enables direct programmatic access to modify the generated dynamic test pattern file. This separation of operations provides a technical advantage in that the conversion component performs the initial, resource-intensive generation of the dynamic test pattern file once, while the manipulation component handles modification of the generated dynamic test pattern file. Additionally, this approach may introduce a level of flexibility previously unavailable in generating ATE pattern files.

Another technical advantage is that the dynamic test pattern file does not need to be fully regenerated after it is modified, thereby bypassing a need for an intermediate simulation output. For instance, specific register transaction value(s) within the generated dynamic test pattern file can be iteratively modified, on-the-fly, using single data transactions, entire data bursts, and the swapping of complete test workloads to test different hardware states, without needing to regenerate the dynamic test pattern file in order to implement an ATE workflow. This approach streamlines validation workflows and yields operational cost savings by saving computational resources and/or disk space because fewer high-performance computing resources are needed for each hardware design validation cycle.

The techniques and apparatuses described herein may have utility across a variety of fields in which it is necessary to validate that a hardware design of a component of a computing device meets applicable standards for functionality, reliability, performance, or quality.

### Testing Environment Overview

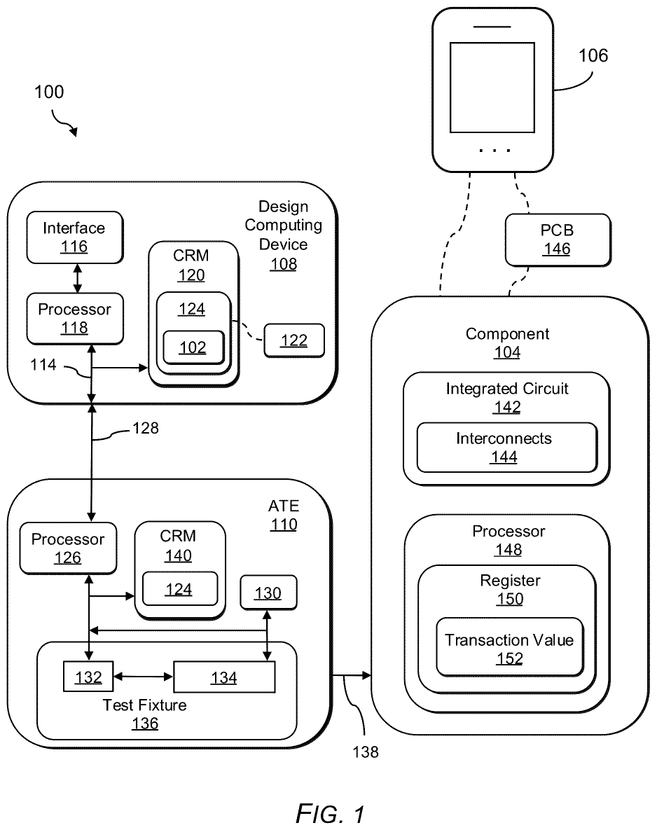

FIG. 1 illustrates example details of a testing environment 100, including operative elements of the testing environment 100 in which systems and techniques for generating a dynamic test pattern file 102 from compiled hardware design code and for modifying the dynamic test pattern file 102. The dynamic test pattern file 102 may correspond to a hardware design of a component 104 of a computing device 106.

The computing device 106 may include one or more components 104, design aspects of which, can be tested using a design computing device 108, an ATE machine 110 and/or an ATE software application 124.

Illustratively, the design computing device 108 may include a bus 114 and a user interface 116, processor(s) 118, and a computer readable storage media (“CRM”) 120, each coupled with the bus 114. The design computing device 108 may also include a software application 124 (e.g., computer readable instructions for the processor(s) 118 to execute) stored in the CRM 120 and having a dynamic test pattern generation and modification mode 122. The processor(s) 118 may include a single-core processor or a multiple-core processor composed of a variety of materials, such as silicon, polysilicon, high-K dielectric, copper, and the like. The CRM 120 may be a hardware-based storage media, which does not include transitory signals or carrier waves. As an example, the CRM 120 may include one or more of a read-only memory (“ROM”), a flash memory, a dynamic random-access memory (“DRAM”), a NOR memory, a static random-access memory (“SRAM”), and so on. The software application stored in the CRM 120 includes executable code or computer readable instructions of a dynamic test pattern file generation and modification software application 124 that, when executed by the processor(s) 118 of the design computing device 108 cause the processor(s) 118 to direct the operative elements of the design computing device (and/or operative elements of an ATE machine 110) to implement the dynamic test pattern file generation and modification mode 122.

The ATE machine 110 may include ATE processor(s) 126, which may include an input/output port 128. The ATE processor(s) 126 may be coupled with ATE CRM 140. The ATE processor(s) 126 may be configured to receive the dynamic test pattern file 102 from the CRM 120 over an input/output port 128, which may connect with a wired or wireless network connection and/or with an external computer readable storage media (not shown) such as a hard drive, a solid state drive, a USB drive, and so on. The ATE machine 110 may also include an ATE software application 124 stored on the CRM 140. The ATE software application 124 may include executable code or computer readable instructions that when executed by the ATE processor(s) 126 direct operative elements of the ATE machine 110 to execute a test workload and/or a test sequence of instructions included in a dynamic test pattern file 102. The dynamic test pattern file 102 outputted by the dynamic test pattern file generation and modification mode 122 of the software application 124 may be used in an ATE workflow to test and/or to validate a component 104 of a computing device 106. Example operative elements of ATE machine 110 may include test equipment and instruments 130 coupled with at least the ATE processor(s) 126, a switching controller 132 coupled with the ATE processor(s) 126, and switching circuit(s) 134 that are coupled with the switching controller 132 and with the test equipment and instruments 130. The switching controller 132 and the switching circuit(s) 134 may be parts of an ATE test fixture 136. The ATE machine 110 may further include an interface test adapter (“ITA”) 138 that couples one or more devices under test. In this discussion, components 104 of the computing device 106 are illustratively shown as coupled with the ATE machine 110 via the ITA 138 as devices under test.

The design computing device 108 is different from both the component 104 and the computing device 106. The design computing device 108 is illustratively depicted as separate from the ATE machine 110. However, the design computing device 108 (including the CRM 120 that stores the software application 124, which generates the dynamic test pattern file 102) could be a component of the ATE machine 110. In that case, a test workload of the dynamic test pattern file 102 could be used by other components, such as ATE processor(s) 126 and ATE CRM 140, to implement the test workload (in an ATE workflow) for a component 104 of a different computing device 106.

Component 104 of the computing device 106 may be an integrated circuit 142 having interconnects 144. The computing device 106 may include a printed circuit board 146. Component 104 may be separate from or coupled with the printed circuit board 146. The component 104 may be, or further include, processor(s) 148. The processor(s) 148 may (each) include one or more quickly accessible programmable locations, called registers 150. Each of registers 150 is programmable to store a register transaction value 152.

Examples of a component 104 of a computing device 106 may include, without limitation: an integrated circuit, a packaged integrated circuit (e.g., a “chip” or “semiconductor chip”), a central processing unit (e.g., a “processor”), a computer readable storage media (e.g., “memory”), a central processing unit (“CPU”), a graphics processing unit (“GPU”), and so on. By way of example, types of packaged integrated circuits may include: a dual in-line (“DIP”) package, a surface-mount-design package (“SMDP”), a small outline integrated circuit (“SOIC”) package, a quad flat package (“QFP”), a ball grid array (“BGA”), a chip-scale package (“CSP”), a flip-chip package (“FCP”), a pin-grid array (“PGA”) package, a land grid array (“LGA”) package, a plastic leaded chip carrier (“PLCC”) package, a thin small outline package (“TSOP”), and a wafer level chip scale package (“WLCSP”).

Examples of file formats that may be incompatible with ATE systems may include: the Unix-based executable and linkable file format (.elf), the text-based hexadecimal file format (.hex), and the S-Record file format (.srec), and the EVCD file format. An example of a file format that may be compatible with an ATE machine 110 and/or with the ATE software application 124 is the .pat file format of pattern files.

In operation, the ATE processor(s) 126 may receive, using the input/output port 128, a dynamic test pattern file 102 outputted from the software application 124 in an ATE file format (e.g., .pat file format). Content of the dynamic test pattern file 102 may include a test workload having one or more register transaction values 152 that correspond uniquely to one or more of the register(s) 150 of the component 104. The register transaction values 152 may include data content and/or data values. The ATE processor(s) 126 may execute the dynamic test pattern file's 102 computer readable instructions to direct operative elements of the ATE machine 110, such as the test equipment and instruments 130, and/or operative components of the ATE software application 124 to execute the test workload's one or more register transaction values 152 to perform an ATE workflow on the component 104 of the computing device 106. The register transaction values 152 may form part of a hardware state of the hardware design of the component 104 of the computing device 106.

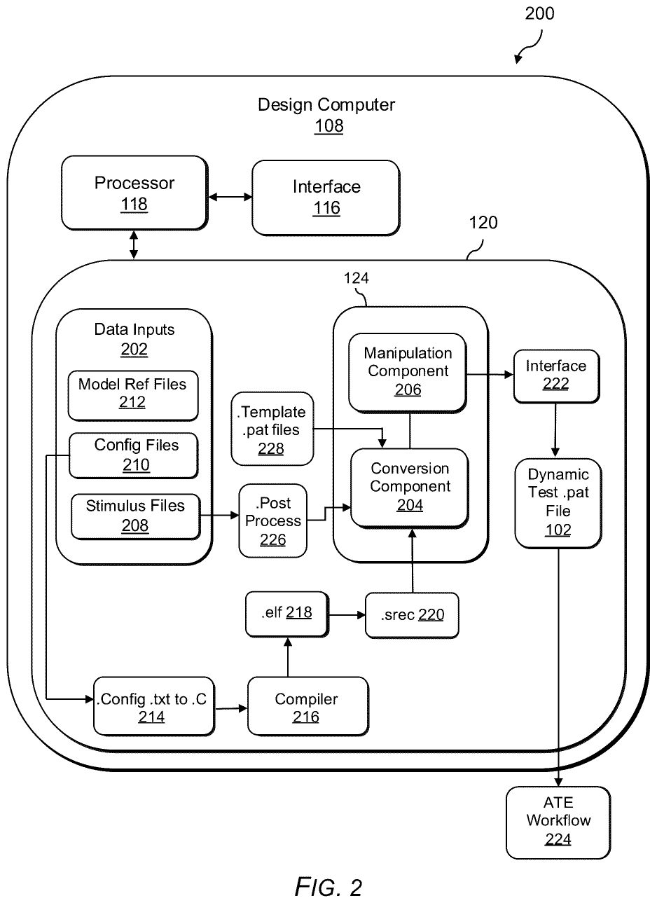

FIG. 2 illustrates example details 200 of the design computing device 108 of FIG. 1, including operative elements of the design computing device 108 and components of a software application 124 that may implement a dynamic test pattern file generation and modification mode 122 (shown in FIG. 1).

Referring to FIG. 2, the software application 124 may be stored in a computer-readable storage media (“CRM”) 120, which is coupled with processor(s) 118. A user interface 116, such as a computer display screen, a keyboard, a mouse, one or more ports configured to transmit and/or receive data from another computing device and/or from an external CRM, and so on, may be coupled with the processor(s) 118.

Data inputs 202, which the conversion component 204 and a manipulation component 206 of the software application 124 use to perform one or more operations of the technique(s) described in this document, may be stored together in a location (or locations) of the CRM 120. By way of example, the data inputs 202 may include stimulus/firmware input(s) 208 in the .hex file format. Data inputs 202 may also include one or more configuration files 210 in the .txt file format. The data inputs 202 may also include model reference files 212 in the .hex file format. Although illustratively shown in FIG. 2 as part of the software application 124, all or some of the data inputs 202 may be stored separately from the software application 124.

Converter component 214 is a set of computer readable instructions that when executed by the processor(s) 118 cause the one or more configuration files 210 to be converted from the .txt file format to the .c file format, where the .c file format corresponds to computer readable instructions converted to the “C” computer language. Compiler component 216 contains computer readable instructions, that when executed by the processor(s) 118 direct the compiler component 216 to compile the converted (e.g., from .txt to .c file format) configuration files 210, and to output them as compiled hardware design code 220 in an executable format, such as the Executable and Linkable Format (.elf file format). The compiled hardware design code 220 may be automatically converted (or translated) into compiled hardware design code 220 in another executable format, such as the S-Record file format (.srec file format). One example of a suitable open-source compiler component that may be used to implement the compiler component 216 is the Gnu Compiler Collection (“GCC”), which supports various computer operating systems, hardware architectures, and programming languages.

The software application 124 may include a conversion component 204 that directly outputs a dynamic test pattern file and a manipulation component 206 that generates a software interface 222 which is configured to directly modify content of the dynamic test pattern file 102. Compiled hardware design code 218 (.elf format) and compiled hardware design code 220 (.srec format) may be outputted from compiler component 216. The software application 124 may be a software engine that includes one or both of the conversion component 204 and the manipulation component 206. The dynamic test pattern file 102, either as initially generated directly from compiled hardware design code 218, 220 or as modified by software interface 222, may be output for use in an automatic test equipment (“ATE”) workflow 224 of a component 104 (FIG. 1) of a computing device 106 (FIG. 1).

Referring to FIG. 1 and FIG. 2, content of the dynamic test pattern file 102 may include a register transaction value 152 (FIG. 1) and/or other information and/or data unique to a hardware design of the component 104 (FIG. 1) of the computing device 106 (FIG. 1). Illustratively, the register transaction value 152 may correspond to a memory register associated with a central processing unit (“CPU”) or a graphic processing unit (“GPU”) that may be included as a part of component 104 (see FIG. 1) of the computing device 106 (see FIG. 1). An ATE machine 110 (FIG. 1) or ATE software application 124 (FIG. 1) compatible with the .pat file format may access the modified dynamic test pattern file 102 to execute a test workload and/or a test sequence stored in the modified dynamic test pattern file 102, to validate a hardware design of a component 104 (see FIG. 1) of a computing device 106 (see FIG. 1). The test workload 102 may include a register transaction value 152, alone or together with other information and/or data, that corresponds to a test vector for an ATE workflow 224 of the component 104.

An application of using the software application 124 in a design computing device 108 is the direct generation of, and post-processing 226 modification of, functional test patterns for complex hardware components 104 (see FIG. 1) of a computing device 106 (see FIG. 1), such as central processing unit (CPU) or a graphics processing unit (GPU). In this context, compiled hardware design code 218, 220 containing register transaction value(s) 152 that form a test workload or a test sequence (e.g., a hardware state) for a hardware design of the CPU or the GPU are used as direct input to the conversion component 204. The conversion component 204 generates the initial dynamic test pattern file 102, and the manipulation component 206 (and/or a software interface 222) is then used to make specific post-processing modifications within the final, modified dynamic test pattern file 102 itself based on an input such as a stimulus/firmware file(s) 208. Content of the stimulus/firmware file(s) 208 may cause the manipulation component 206 and/or the software interface 222 to alter register transaction values within the dynamic test pattern file 102 to test different hardware states or to swap entire test workloads to increase coverage, all without re-running lengthy simulations of the hardware designs and without requiring regeneration of the hardware design pattern files.

### Software Architecture

Referring to FIG. 2, various embodiments of the dynamic test pattern file generation and modification techniques in this document can be implemented using a modular software architecture for the software application 124. The software application 124 and its components 204, 206 may be programmed using any suitable computer coding language. Interactions among the components 204, 206 facilitate a structured data flow from the initial compiled hardware design code 220 to the dynamic test pattern file 102.

The software application 124 includes a set of interconnected software components (including, a conversion component 204 and a manipulation component 206) that process input compiled hardware design code 218, 220 to generate, and thereafter modify, a dynamic test pattern file 102, which is output in an ATE file format (such as .pat). The dynamic test pattern file 102 that is initially generated, and that may be modified, is configured to handle different types of write transactions, including single data transactions, burst data transactions, and any suitable combination thereof.

### Conversion Component

Referring again to FIG. 2, the conversion component 204 of the software application 124 is configured to receive a compiled hardware design code 218, 220 as an input. The conversion component 204 (which could also be referred to as a “conversion engine”) may also access a template pattern file 228 (in the .pat file format) as an input. The conversion component 204 contains computer readable instructions that when executed by the processor(s) 118 cause machine instruction sections and data sections of the compiled hardware design code 220 (for a hardware design of a component 104 (“FIG. 1”) to be parsed and directly converted into a dynamic test pattern file 102 in an ATE file format. This direct conversion process eliminates the requirement to run a fully functional simulation of a hardware design of a component 104 (see FIG. 1) to capture test vectors needed for an ATE workflow validation of the hardware design.

The conversion component 204 and manipulation component 206 may function in a complementary and sequential relationship. The conversion component 204 first performs the initial conversion (or translation) from compiled hardware design code 218, 220 and/or integration of the compiled hardware design code 218, 220 with a template pattern file 228 to directly generate an initial dynamic test pattern file 102. The conversion component 204 then outputs the generated dynamic test pattern file 102 (FIG. 1) to be an input for the manipulation component 206 and/or the software interface 222.

### Manipulation Component

Referring to FIG. 1 and FIG. 2, the manipulation component 206 (e.g., a “manipulation module”) of software application 124 includes computer readable instructions that when executed by the processor(s) 118 cause content of the dynamic test pattern file 102 (FIG. 1) to be directly programmatically accessed and modified with the stimulus/firmware files 208, which may be in the .hex file format.

To facilitate a user or an automatic script directly accessing and modifying the dynamic test pattern file 102 after it is generated directly from the compiled hardware design code 218, 220, the manipulation component 206 of the software application 124 may be configured to generate a software interface 222. This software interface 222 enables a user and/or an automatic script to programmatically access and directly modify content of the dynamic test pattern file 102 itself after it is output by the conversion component 204. Since content(s) of the dynamic test pattern file 102 are directly modified to include a test workload and/or a test sequence, regeneration of the dynamic test pattern file 102 is not required to implement an ATE workflow 224.

The manipulation component 206 may be programmed to understand the structure of the dynamic test pattern file 102 (FIG. 1), enabling register transaction values and/or other information and/or data (e.g., test workloads) within the dynamic test pattern file 102 (FIG. 1) to be located and modified without corrupting the dynamic test pattern file's integrity.

This modular separation of functions allows the computationally intensive task of initial pattern generation to be performed once, while the manipulation component 206 handles subsequent, frequent modifications. Once the manipulation component 206 has modified one or more register transaction values of the dynamic test pattern file 102 (FIG. 1), the final, modified dynamic test pattern file 102 (FIG. 1), now in an ATE file format, may be stored in the CRM 120. This final, modified dynamic test pattern file 102 may be used by an ATE machine 110 (FIG. 1) and/or an ATE software application 124 (FIG. 1) in an ATE workflow 224 to validate and/or test one or more components 104 (FIG. 1) of a computing device 106 (FIG. 1).

### Software Interface

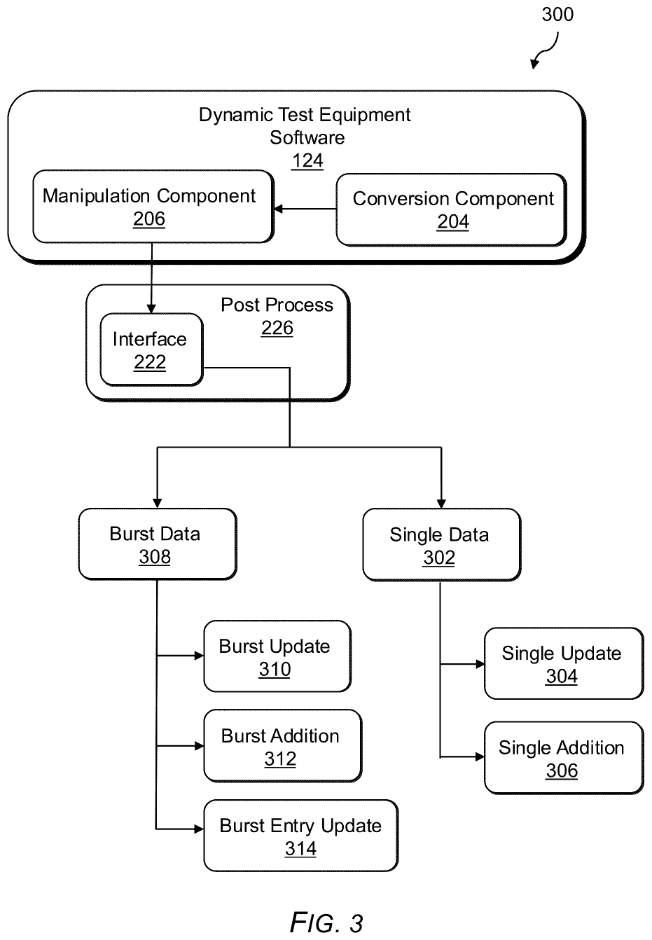

FIG. 3 is a diagram 300 illustrating further example details of how a software interface 222 (e.g., a “workload adjustment feature”) generated by a manipulation component 206 of a software application 124 may write post-processing 226 modification(s) to a dynamic test pattern file 102 that was directly generated from a compiled hardware design code 220 (FIG. 2). The dynamic test pattern file 102 that is generated, and which is modified, corresponds to a hardware design for a component 104 (FIG. 1) of a computing device 106 (FIG. 1 and FIG. 2) and may be used in an ATE workflow 224. The modification(s) may include computer-readable instructions representing a test workload or a test sequence for the ATE workflow 224.

Referring to FIG. 3 (and to FIG. 1 and FIG. 2 as needed), the manipulation component 206 (FIG. 2) of software application 124 (of FIG. 1 and FIG. 2) may be programmed to receive as an input a stimulus/firmware file 208 (FIG. 2) and may be also be programmed to implement a software interface 222 that is configured to output computer-readable instructions to the processor(s) 118, that when executed by the processor(s) 118, cause content of the generated dynamic test pattern data file 110 (of FIG. 1 and FIG. 2) to be directly accessed and modified to correspond to content in the stimulus/firmware file 208. For single data transactions 302, the manipulation component 206 and/or the software interface 222 can be configured access the stimulus/firmware file 208 and thereafter to update an existing single register transaction value 304 or add a new information and/or data entry 306 within the dynamic test pattern file 102 to create a test workload or a test sequence. For more complex burst data transactions 308, the manipulation component 206 and/or the software interface 222 may be configured to access the stimulus/firmware file 208 and thereafter update an entire data burst 310, add a new burst 312, modify a specific entry within an existing burst 314, or any suitable combination thereof within the dynamic test pattern file 102 to create a test workload or test sequence of a hardware state of component 104.

### Computer-implemented Method(s)

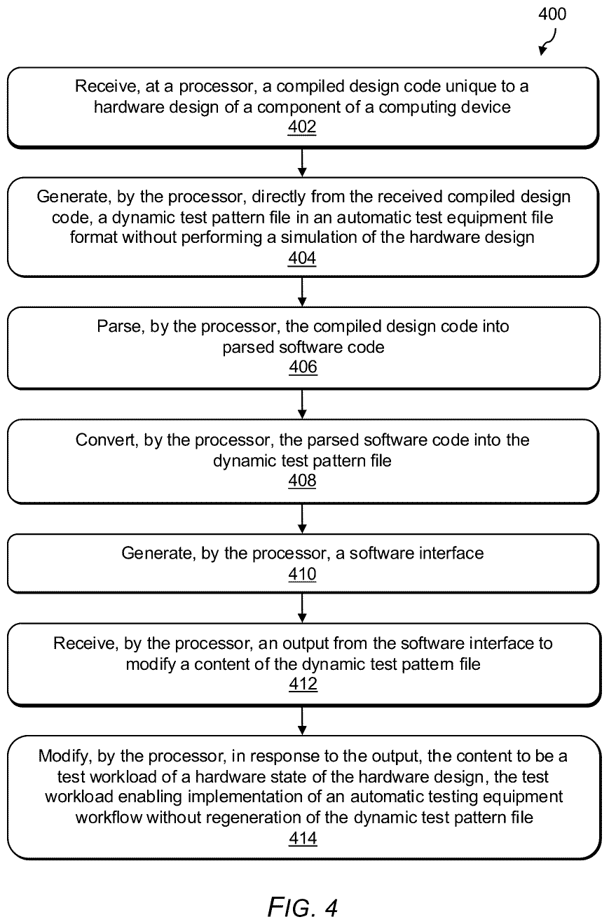

FIG. 4 depicts an example computer-implemented method 400. The computer-implemented method 400 is shown as a set of blocks that specify operations performed by one or more computer processor(s) 118 (FIG. 1), but such operations are not necessarily limited to the order or combinations shown in FIG. 4. Unless specified otherwise, one or more of the operations shown may be repeated, combined, reorganized, or linked to provide a wide array of additional and/or alternate methods. In portions of the following discussion, reference may be made to the example testing environment 100 of FIG. 1 or to entities or processes as detailed in other drawings, reference to which is made for example only. The techniques are not limited to performance by one entity or multiple entities operating on one device.

Referring now to FIG. 4 (and to FIG. 1 and FIG. 2 as needed), block 402 illustrates that computer-implemented method 400 may begin when a processor(s) 118 (FIG. 1) receives a compiled hardware design code 218, 220 (FIG. 2) unique to a hardware design of a component 104 (FIG. 1) of a computing device 106 (FIG. 1).

At block 404, the processor(s) 118 generates, from the received compiled hardware design code 220 (FIG. 2), a dynamic test pattern file 102 (FIG. 1) without performing a simulation of the hardware design. Because the hardware design includes one or more hardware states (of elements of the component 104), excluding a fully functional simulation of the hardware design when generating the dynamic test pattern file 102 saves both time and computing resources, each of which is a technical advantage.

At block 406, the processor(s) 118 parses the compiled hardware design code 220 into parsed software code. At block 408, the processor(s) 118 converts the parsed software code into the dynamic test pattern file in an ATE file format. The parsed software code may separate data from machine instructions. The parsing operation represented by block 406 and the conversion operation represented by block 408 may be sub-operations of the dynamic test pattern file generating operation represented by block 404.

At block 410, the processor(s) 118 (FIG. 1) may generate a software interface 222 (FIG. 2). This is accomplished by executing computer-readable instructions of the manipulation component 206 (FIG. 2). The software interface 222 is configured to facilitate direct programmatic access to modify a content of the dynamic test pattern file 102 after the dynamic pattern file 102 is created.

At block 412, the processor(s) 118 receives an output from the software interface 222 (FIG. 2) and/or from the manipulation component 206 (FIG. 2) to modify a content of the generated dynamic pattern file 102. The output of the software interface 222 may correspond to an input from either a user of the design computing device 108 (FIG. 1) (or of the ATE machine 110 and/or of the ATE software application 124) or to one or more the data input(s) 202 (FIG. 2).

At block 414, in response to the output, the processor(s) 118 (FIG. 1) modifies the content to be a test workload (or test sequence) of a hardware state of the hardware design of the component 104 (FIG. 1). The test workload enables implementation of an ATE workflow 224 (FIG. 2) without regenerating the dynamic pattern file. The test workload may include one or more hardware states of another computing device (e.g., the computing device 106 in FIG. 1), each hardware state being unique to a particular ATE test vector at a particular time. Since the dynamic pattern file 102 (FIG. 1) is generated in an ATE file format, modifying the content of the dynamic pattern file 102 enables subsequent implementation of an ATE workflow 224 (FIG. 2) without regenerating the dynamic pattern file 102, which saves time and computing resources.

In the computer-implemented method 400 just described, the compiled hardware design code 220 (FIG. 2), may be in a format such as an Executable and Linkable Format (.elf file format) and/or in a S-record (.srec file format). In addition to the compiled hardware design code, the processor(s) 118 may receive a template pattern file 228 (FIG. 2), model reference files 212 (FIG. 2) and a configuration file 210 (FIG. 2). Each of the template pattern file 228 and the configuration file 210 may be in an ATE file format (e.g., in a non-EVCD file format), which can be implemented in an ATE validation workflow without further conversion. Also illustratively, the content of the generated ATE-compatible dynamic test pattern file 102 (FIG. 1) may correspond to a functional test pattern for a hardware design of a semiconductor chip, including but not limited a CPU and/or a GPU.

Embodiments of the computer-implemented method 400 can be performed by various processing systems. Structural equivalents include, but are not limited to, a general-purpose computer programmed with specific software, a dedicated hardware accelerator, or a cloud-based computing environment configured to execute the conversion operations and manipulation operations set forth in this document.

The preceding discussion describes systems and techniques related to generating a dynamic test pattern file directly from compiled code that corresponds to a hardware design of a component of a computing device and directly modifying the dynamic test pattern file so that a full functional simulation of the hardware design is bypassed. These techniques may be implemented using one or more of the components shown in the drawings. Thus, these drawings illustrate some of the many possible systems or apparatuses capable of employing the described techniques.

What is claimed is:

1. A computer-implemented method, comprising:
receiving, at a processor, a compiled hardware design code unique to a hardware design of a component of a computing device;
generating, by the processor, from the compiled hardware design code and without performing a simulation of the hardware design, a dynamic test pattern file in an automatic test equipment file format;
receiving, by the processor, an output received through a software interface, the output to modify a content of the dynamic test pattern file; and
modifying, by the processor in response to the output, the content to be a test workload of a hardware state of the hardware design, the test workload enabling an automatic test equipment workflow based on the dynamic test pattern file as modified in response to the output.

2. The computer-implemented method of claim 1, wherein generating, by the processor, further comprises:
parsing, by the processor, the compiled hardware design code into parsed software code; and
converting, by the processor, the parsed software code into the dynamic test pattern file.

3. The computer-implemented method of claim 1, wherein the content of the dynamic test pattern file comprises a register transaction value.

4. A computing device, comprising:
a processor;
a bus; and
a computer-readable storage media coupled with the processor and the bus, the computer-readable storage media including computer-readable instructions that when executed by the processor cause the computing device to:
receive, at the processor, a compiled hardware design code unique to a hardware design of a component of the computing device;
generate, by the processor, from the compiled hardware design code and without performing a simulation of the hardware design, a dynamic test pattern file in an automatic test equipment file format;
receive, by the processor, an output received through a software interface, the output to modify a content of the dynamic test pattern file; and
modify, by the processor in response to the output, the content to be a test workload of a hardware state of the hardware design, the test workload enabling an automatic test equipment workflow based on the dynamic test pattern file as modified in response to the output.

5. The computing device of claim 4, the computer-readable storage media further including computer-readable instructions that when executed by the processor cause the computing device to:
parse the compiled hardware design code into parsed software code; and
convert the parsed software code into the dynamic test pattern file.

6. The computing device of claim 4, wherein the computing device is a component of an automatic test equipment machine.
